(19) United States
(12) Patent Application Publication
(10) Pub. No.: US 2014/0167511 A1
(43) Pub. Date: Jun. 19, 2014

(54) FAN CONTROL BOARD

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: BO TIAN, Shenzhen (CN); KANG WU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/848,040

(22) Filed: Mar. 20, 2013

(30) Foreign Application Priority Data
Dec. 13, 2012 (CN) 201210537330.5

(51) Int. Cl. H02J 1/06

(52) U.S. Cl. CPC H02J 1/06
USPC 307/41

(57) ABSTRACT

A fan control board with a fan control function is applied in an electronic device. The device includes a number of first connectors, a number of switches, a number of second connectors, and a control chip. Each first connector is connected to one of fan connectors of a main board of the electronic device. Each second connector is connected to one of the first connectors, one fan of the electronic device, and the control chip via one switch. The control chip is further connected to a power source of the electronic device. The control chip sequentially turns on one of the switches when the electronic device is powered on.

### BACKGROUND

1. Technical Field

The present disclosure relates to control boards and, particularly, to a control board having a fan control function.

2. Description of Related Art

In the development and test stage, an electronic device (e.g. a server) may not start up normally as the instantaneous current is too large on startup. Accordingly, designers should consider how to decrease the instantaneous current on startup. It is known that turning on all the fans sequentially can decrease the instantaneous current on startup, but it is not certain the device will start normally without all the fans on at once. Thus, before modifying on board programs to turn on the fans sequentially, the designers should confirm whether the device can start up normally under such conditions. Therefore, it is desirable to provide a fan control board to help the designers very that the device can start up normally when the fans are turned on sequentially.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram showing how to use a fan control board, in accordance with an exemplary embodiment.

FIG. 2 is a block diagram of function modules of the fan control board of FIG. 1, in accordance with an exemplary embodiment.

### DETAILED DESCRIPTION

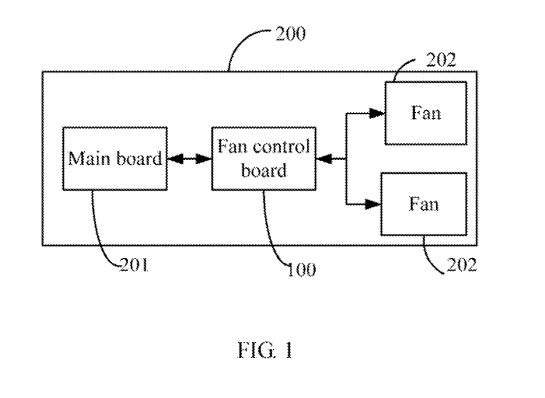

FIG. 1 shows that a fan control board 100 is connected between a main board 201 and a number of fans 202 of an electronic device 200. In this embodiment, the electronic device 200 is a server. In the development and test stage, the electronic device 200 cannot start up normally as the instantaneous current is too large on startup. The fan control board 100 is used to activate the fans 202 sequentially to decrease the instantaneous current of the electronic device 200. If the electronic device 200 can then start up normally when the fans 202 are turned on sequentially, designers can modify the programs to turn on the fans 202 sequentially on startup.

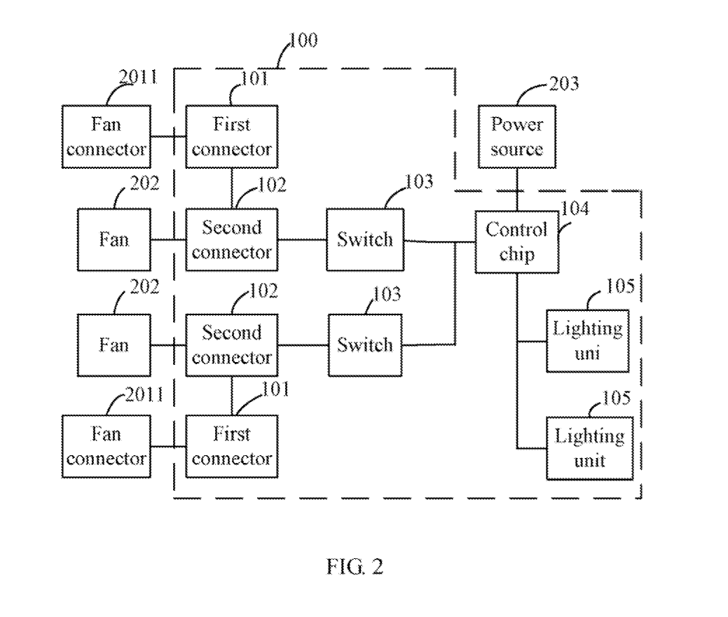

Referring to FIG. 2, the fan control board 100 includes a number of first connectors 101, a number of second connectors 102, a number of switches 103, and a control chip. Each first connector 101 is connected to a fan connector 2011 of the main board 201 and one second connector 102. Each second connector 102 is further connected to one fan 202, and connected to the control chip 104 via one switch 10. The control chip 104 is further connected to a power source 203 of the electronic device 200. In this embodiment, when the electronic device 200 is powered on, the control chip 104 sequentially turns on the switches 103 to allow the power source to sequentially provide power to the fans 202 connected to the turned on switches 103. That is, when the electronic device 200 is powered on, the fan control board 100 activates the fans 202 sequentially to decrease the instantaneous current of the electronic device 200. If the electronic device 200 can start up normally when the fans 202 are activated sequentially, designers can modify the programs to control the fans 202 to turn on the fans 202 sequentially.

In this embodiment, the fan control board 100 further includes a number of lighting units 105 each corresponding to one switch 103. When the control chip 104 turns on one switch 103, the control chip 104 controls the corresponding lighting unit 105 to light, thus the designers can clearly learn the number of the activated fans 202. In this embodiment, each lighting unit 105 is an LED.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A fan control board applied in an electronic device, comprising:
a plurality of first connectors each to be connected to one of a plurality of fan connectors of a main board of the electronic device;
a plurality of switches;
a plurality of second connectors, each of the plurality of second connectors to be connected to one of the first connectors, one of a plurality of fans of the electronic device, and a control chip via one of the switches; and
the control chip further to be connected to a power source of the electronic device, and to sequentially turn on the switches when the electronic device is powered on.

2. The fan control board as described in claim 1, further comprising a plurality of lighting units connected to the control chip, wherein each of the lighting units corresponds to one of the switches, when the control chip turns on one of the switches, the control chip is to turn on the corresponding lighting unit.

3. The fan control board as described in claim 2, wherein each of the lighting units is an LED.
